(19) United States
(12) Patent Application Publication
(10) Pub. No.: US 2026/0077987 A1
(43) Pub. Date: Mar. 19, 2026

(54) DRIVE SYSTEM FOR A WORK VEHICLE

(71) Applicant: Palfinger AG, Bergheim bei Salzburg (AT)

(72) Inventors: Christian ROSENHAMMER, Bergheim bei Salzburg (AT); Mario HASLAUER, Bergheim bei Salzburg (AT)

(21) Appl. No.: 19/327,673

(22) Filed: Sep. 12, 2025

(30) Foreign Application Priority Data
Sep. 13, 2024 (AT) GM 50118/2024

(51) Int. Cl. B66F 9/22; B66F 9/075; E02F 9/22

(52) U.S. Cl. CPC B66F 9/22; B66F 9/07563; E02F 9/2235; E02F 9/2242

(57) ABSTRACT

A drive system is provided for a work vehicle, for example a truck-mounted forklift, with at least one consumer. The drive system includes a hydraulic pump configured to drive the at least one consumer, an electric motor mechanically coupled to the hydraulic pump, with the electric motor being configured to drive the hydraulic pump, and an open-loop or closed-loop control unit for open-loop or closed-loop controlling the electric motor and/or the hydraulic pump. The open-loop or closed-loop control unit is configured to open-loop or closed-loop control a volume flow that can be generated by the hydraulic pump.

### BACKGROUND OF THE INVENTION

The present invention relates to a drive system for a work vehicle, for example a truck-mounted forklift, with at least one consumer. The drive system comprises:
a hydraulic pump which is configured to drive the at least one consumer,
an electric motor mechanically coupled to the hydraulic pump, with said electric motor being configured to drive the hydraulic pump, and
an open-loop or closed-loop control unit for open-loop or closed-loop controlling the electric motor and/or the hydraulic pump.

The invention also relates to a work vehicle with such a drive system.

Drive systems of the type are used primarily in compact electric work vehicles, such as forklifts, excavators, or the like, where they are intended in particular for driving the lifting unit, such as a fork carrier or a shovel. The lifting unit comprises at least one consumer, often several consumers, wherein each consumer has a specific function. For example, the functions of the consumers can be lifting and lowering, tilting up and down, or supporting the vehicle on the ground by means of support legs. In order to perform their functions, the consumers have a certain power requirement, which is met by supplying pressure and volume flow generated by a hydraulic pump.

In drive systems of the prior art, the power requirement is usually covered entirely by generating the required pressure. The disadvantage of this is that the operation of such a drive system requires a large amount of energy, especially if several consumers are to be used simultaneously, e.g., to drive the work vehicle and to lift, move sideways, and tilt upward a load with the fork carrier.

### SUMMARY OF THE INVENTION

The task of the present invention therefore is to provide a drive system by which energy consumption can be optimized to a minimum.

This task is solved by a drive system of the type mentioned at the beginning, in which the open-loop or closed-loop control unit is configured to open-loop or closed-loop control a volume flow that can be generated by the hydraulic pump.

The open-loop or closed-loop control of the volume flow as open-loop or closed-loop control variable advantageously forms the basis for operating the drive system in a particular energy-efficient manner. Consequently, this means, in particular, that the at least one consumer is supplied with at most as much power as it actually requires in view of its maximum power demand. The drive system according to the invention can therefore significantly contribute to saving energy.

The at least one consumer is in particular a hydraulic consumer, in particular a hydraulic cylinder.

If the work vehicle is a truck-mounted forklift, forklift or the like, then the at least one consumer is preferably five consumers, which are intended for operating a fork carrier and a support device of the forklift, in particular wherein one consumer each can be responsible for the functions of lifting and lowering, increasing and reducing the reach, tilting up and down, moving the fork carrier to the left and right and moving a support device up and down.

In preferred embodiments, the hydraulic pump for driving the at least one consumer is a

one-way pump.

It is particularly preferred that the open-loop or closed-loop control unit is configured to

open-loop or closed-loop control the volume flow at a request of the at least one consumer. This can mean, in particular, that the at least one consumer determines the energy consumption at the hydraulic pump in order to cover its power demand. Advantageously, such a direct demand request allows for a precise and therefore energy-efficient open-loop or closed-loop control.

In preferred embodiments, the demand of the at least one consumer corresponds to a defined maximum power requirement of the at least one consumer, in particular in such way as to enable the at least one consumer to perform its assigned function in the best way possible.

It is conceivable that the request of the at least one consumer cannot be complied with, for example because the maximum volume flow that can be generated by the hydraulic pump can be limited by the design of the hydraulic pump, in particular with regard to its maximum revolutions per minute. Especially, if several consumers request volume flow, it is possible that one or more requests of one or more consumers cannot be complied with. However, this circumstance can be accepted as this way the advantage of low energy consumption is back in play.

The hydraulic pump is preferably configured to come to a standstill without a request from a consumer. In a variable displacement pump, this can be achieved primarily by a swivel angle in the neutral position or by the motor coming to a standstill, which is absolutely necessary in a constant pump in order to reach the state of a standstill. In other words, the hydraulic pump is advantageously only active if at least one function is activated.

The electric motor can be configured to be open-loop or closed-loop controlled by at least one signal generated by the request of the at least one consumer. The at least one signal can be a mechanical, electrical, or hydraulic signal, and can be converted and/or obtained by signal conversion.

The open-loop or closed-loop control unit is configured to generate a proportional and/or constant volume flow depending on a function of the consumer.

This means, preferably, that the open-loop or closed-loop control unit is configure to

configured to

open-loop or closed-loop control the hydraulic pump and/or the electric motor in such way that a proportional and/or constant volume flow is generated.

It is possible that only a proportional volume flow or only a constant volume flow is generated.

It is also possible that the volume flow is a superposition of a proportional and a constant volume flow and/or that a proportional and a constant volume flow are generated alternately.

In a truck-mounted forklift, forklift, or the like, for example, the function of lifting and lowering and the function of increasing and decreasing the reach are proportional in their power requirements, so that the consumers request a proportional volume flow to perform these functions, especially when they are actuated.

The open-loop or closed-loop control unit is preferably configured to open-loop or closed-loop control the volume flow on the basis of the revolutions per minute of the hydraulic pump and/or the displacement volume per revolution of the hydraulic pump.

In particularly preferred embodiments, the hydraulic pump is a constant pump with a constant displacement volume per revolution of the hydraulic pump. Preferably, the open-loop or closed-loop control unit is configured to open-loop or closed-loop control the volume flow on the basis of the revolutions per minute of the hydraulic pump.

Particularly preferred, the open-loop or closed-loop control unit is configured to open-loop or closed-loop control the electric motor, preferably the revolutions per minute of the electric motor, and/or on the basis of at least one request from one or more consumers.

In other embodiments, the hydraulic pump is a variable displacement pump, and the

open-loop or closed-loop control unit is preferably configured to open-loop or closed-loop control the volume flow based on an adjustment parameter such as a swivel angle and/or the revolutions per minute of the hydraulic pump.

In preferred embodiments, the open-loop or closed-loop control unit is configured to open-loop or closed-loop control the volume flow by at least one function request to the at least one consumer by an operator, preferably in real time.

The at least one function request can be made, for example, by an operator actuating a lever, button, etc., whereby the actuation can take place in or on the work vehicle and/or also be remote-controlled. It is also conceivable that the function request can be made by an autonomous system, etc.

Preferably, at least the electric motor and the hydraulic pump form a first hydraulic drive train for driving the at least one consumer, and preferably the at least one consumer comprises at least two, for example four or five, consumers.

At least one pressure relief valve can be provided in the first drive train, in particular, wherein the at least one pressure relief valve is arranged upstream of at least one consumer.

At least one multi-way valve, for example operable by a lever, is provided in the first drive train, in particular with the at least one consumer being activable by the multi-way valve. The first drive train is also preferably an open hydraulic circuit.

In particularly preferred embodiments, the open-loop or closed-loop control device is configured to open-loop or closed-loop control the volume flow based on a sum of the individual requests of the at least two consumers.

As mentioned above, it is conceivable and, for energy-saving purposes, preferable that the sum of the requests exceeds the maximum power of the hydraulic pump, so that one or more consumers are not operated according to their respective maximum power requirements.

For example, a maximum number of revolutions per minute of 3000 revolutions can be available for the hydraulic pump. A first function requires 1000 revolutions, a second function 600 revolutions, and a third function 1500 revolutions. Therefore, 3100 revolutions would have been requested, leading to an undersupply of one function. For the advantage of lower energy consumption, it can be acceptable, for example, to operate only one function at 2000 revolutions.

Particularly preferably, a primary consumer with a defined power requirement is arranged upstream of the at least one consumer in the first drive train. Preferably, the drive system is configured to supply the primary consumer with a quantity of hydraulic fluid to cover its defined power requirement. This has the advantage of ensuring that the primary consumer can be operated in an optimal way at all times in accordance with its required power demand and that an undersupply of the primary consumer is reliably avoided.

The primary consumer preferably is a hydraulic cylinder of a steering system of the work vehicle. This means, in particular, that the work vehicle can always be steered reliably and safely.

The drive system can have at least a second hydraulic drive train with a second electric motor and a second hydraulic pump mechanically coupled to the second electric motor.

It is particularly preferred that the first drive train and the at least one second drive train are configured separately from each other, i.e., in particular hydraulically unconnected. However, it is also conceivable that the first drive train and the at least one second drive train are hydraulically connected to each other, for example for pressure compensation purposes.

In preferred embodiments, the second drive train has at least one hydraulic motor, preferably for driving at least one wheel of the work vehicle, and preferably the second hydraulic pump is configured to drive the at least one hydraulic motor. Preferably, the second drive train is a closed hydraulic circuit.

Preferably, the second hydraulic pump is a two-way pump, in particular with a variable delivery volume.

Furthermore, protection is sought for a work vehicle, in particular a truck-mounted forklift, with a drive system according to the invention and at least one consumer that can be driven by the drive system.

The at least one consumer is in particular a hydraulic consumer, preferably a hydraulic cylinder.

Particularly preferred, the work vehicle is a forklift with several, preferably five, consumers for operating a fork carrier and a support device of the forklift, in particular, wherein one consumer each is provided for the functions of lifting and lowering, increasing and reducing the reach, tilting up and down, shifting left and right of the fork carrier and moving the support device up and down.

### BRIEF DESCRIPTION OF THE DRAWINGS

Further features and advantages of the invention will be apparent from the following description with reference to the drawings, in which:

FIGS. 1-3 are section views of a preferred embodiment of a drive system according to the invention.

The sections shown in FIGS. 1-3 together form the preferred embodiment of a drive system 1 according to the invention. In particular, FIG. 1 shows a main section of the drive system 1 with a first drive train 7, FIG. 2 shows a primary consumer 8 provided in the first drive train 7, and

FIG. 3 shows an optional second drive train 9.

### DETAILED DESCRIPTION OF THE INVENTION

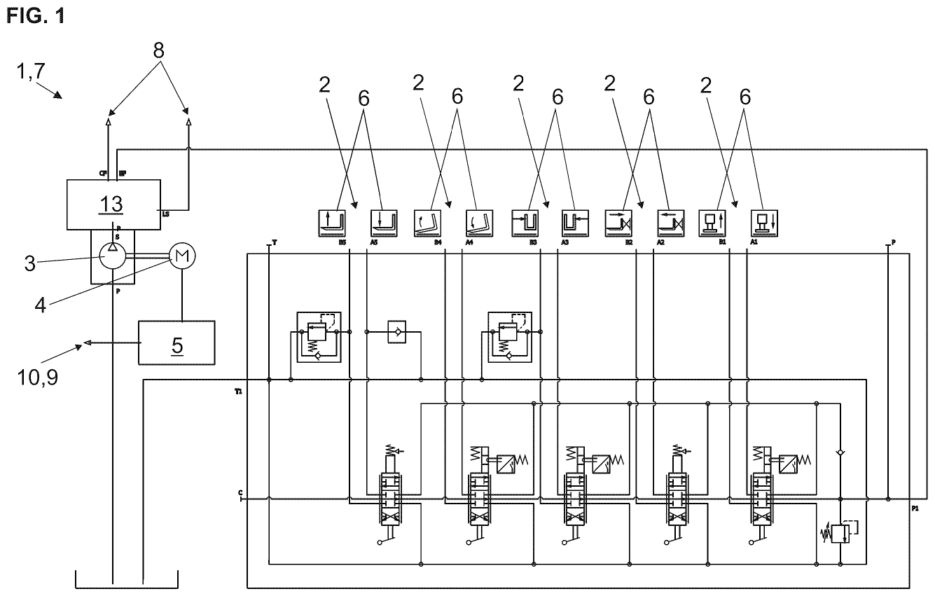

FIG. 1 shows a section of a preferred embodiment of a drive system 1 for a work vehicle, for example a truck-mounted forklift, with at least one consumer 2. The drive system 1 comprises:
a hydraulic pump 3 which is configured to drive the at least one consumer 2,
an electric motor 4 mechanically coupled to the hydraulic pump 3, with said electric motor 4 being configured to drive the hydraulic pump 3, and
an open-loop or closed-loop control unit 5 for open-loop or closed-loop controlling the electric motor 4 and/or the hydraulic pump 3.

The open-loop or closed-loop control unit 5 is configured to open-loop or closed-loop control a volume flow that can be generated by the hydraulic pump 3.

In this preferred embodiment, the open-loop or closed-loop control unit 5 is configured to open-loop or closed-loop control the electric motor 4.

Furthermore, in this example, at least the electric motor 4 and the hydraulic pump 3 form a first hydraulic drive train 7, which is configured to drive at least one consumer 2, here in an exemplary manner five consumers 2.

The consumers 2, preferably hydraulic cylinders, are not shown; they would be connected to the hydraulic lines extending upward. However, a total of five exemplary functions 6 that can be performed by the consumers 2 are shown. These five functions 6 are, from left to right: lifting and lowering a fork carrier of a work vehicle, tilting the fork carrier up and down, moving the fork carrier to the left and right, increasing and reducing the reach of the fork carrier, and moving a support device up and down.

In this embodiment, the open-loop or closed-loop control unit 5 is configured to open-loop or closed-loop control the volume flow at the request of at least one consumer 2, i.e., in particular at the request of one or more consumers 2 of the five existing consumers 2.

Preferably, the request from the respective consumer 2 corresponds to a defined maximum power requirement of this consumer 2.

Since there are several consumers 2 here, the open-loop or closed-loop control device 5 is preferably configured to open-loop or closed-loop control the volume flow based on a sum of the individual requests of the at least two consumers 2.

In this embodiment, the open-loop or closed-loop control unit 5 is configured to generate a proportional and/or constant volume flow depending on the respective function 6 of the respective consumer 2.

Preferably, the hydraulic pump 3 is a constant pump with a constant displacement volume per revolution of the hydraulic pump 3, wherein the open-loop or closed-loop control unit 5 is configured to open-loop or closed-loop control the volume flow based on the revolutions per minute of the hydraulic pump 3.

It is also conceivable that the open-loop or closed-loop control unit 5 is configured to open-loop or closed-loop control the volume flow based on a displacement volume per revolution of the hydraulic pump 3.

In this embodiment, the open-loop or closed-loop control unit 5 is configured to open-loop or closed-loop control the volume flow by means of at least one function request to the at least one consumer 2 by an operator. For example, an operator can actuate a lever on a work vehicle to perform one or more functions 6, e.g., lifting and/or tilting a fork carrier, whereupon the associated consumer 2 or consumers request a volume flow required for the function(s) 6.

In particular, the open-loop or closed-loop control and the subsequent processes take place in real time, i.e., in particular immediately as a result of the at least one function request.

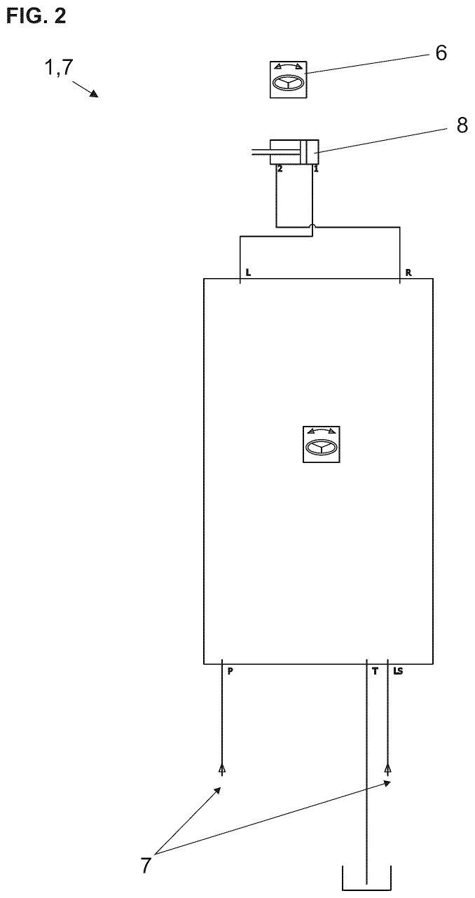

In FIG. 1, a valve 13 is arranged adjacent to the hydraulic pump 3 as a preferred variant, starting from said valve 13 a primary consumer 8 (shown in FIG. 2) is provided, preferably with the primary consumer 8 being arranged upstream of the at least one consumer 2 in the first drive train 7.

The valve 13 is preferably a changeover valve, in particular a load-sensing valve functioning as a priority valve, which is configured in particular to ensure that the defined power requirement of the primary consumer 8 is always met.

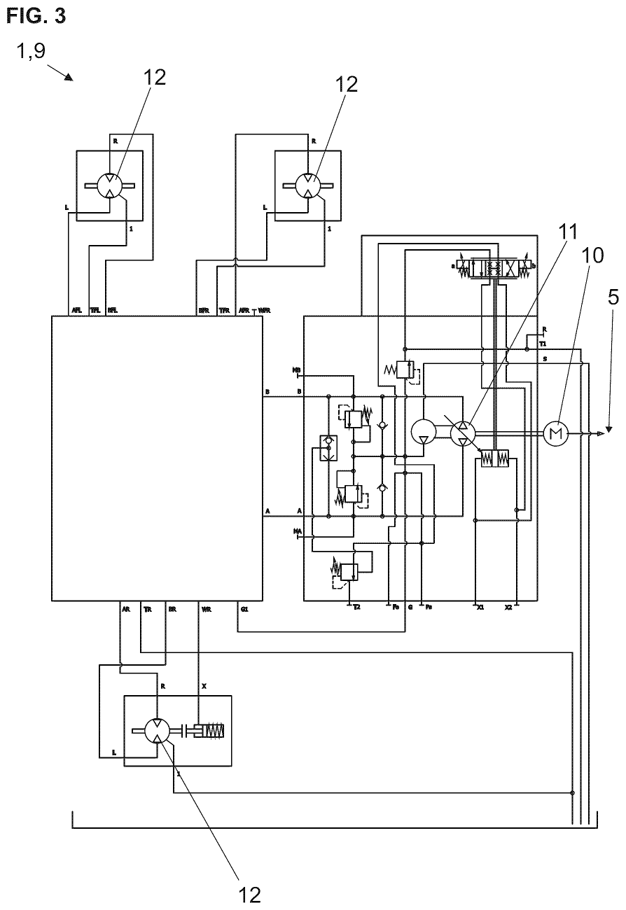

In FIG. 1, a control line leading from the open-loop or closed-loop control unit 5 to the preferably provided second drive train 9, in particular to the second electric motor 10 of the second drive train 9, is further shown as a preferred variant (see FIG. 3).

FIG. 2 shows a second section of the preferred embodiment of a drive system 1, wherein the primary consumer 8 mentioned in FIG. 1 is shown, which is arranged upstream of the at least one consumer 2 in the first drive train 7.

In this embodiment, the drive system 1 is configured, in particular by the valve 13, to supply the primary consumer 8 with a quantity of hydraulic fluid for covering the defined power requirement of the primary consumer 8.

The primary consumer 8 in particular is a hydraulic cylinder for a steering system, preferably wherein a gear rack is provided on the hydraulic cylinder for performing a rotary movement. This means in particular that the function 6 of this primary consumer 8 is to steer the work vehicle.

FIG. 3 shows a third section of the preferred embodiment of a drive system 1, wherein in this case at least one second hydraulic drive train 9 with a second electric motor 10 and with a second hydraulic pump 11 mechanically coupled to the second electric motor 10 is shown.

Starting from the second electric motor 10, a control line is shown which is connected to the open-loop or closed-loop control unit 5 (see FIG. 1).

The open-loop or closed-loop control unit 5 in particular is configured to open-loop or

closed-loop control the first drive train 7 and the second drive train 9.

In this preferred embodiment, the first drive train 7 and the second drive train 9 are not hydraulically connected to each other.

In this example, the second drive train 9 has at least one hydraulic motor 12, in particular three hydraulic motors 12.

In this case, each hydraulic motor 12 in particular is configured to drive one wheel of the work vehicle, preferably wherein the second hydraulic pump 11 is configured to drive the at least one hydraulic motor 12.

In this embodiment, the second hydraulic pump 11 is a two-way pump, preferably with a variable delivery volume.

### LIST OF REFERENCES

1 drive system
2 consumer
3 hydraulic pump
4 electric motor
5 open-loop or closed-loop control unit
6 function
7 first drive train
8 primary consumer
9 second drive train
10 second electric motor
11 second hydraulic pump
12 hydraulic motor
13 priority valve

1. A drive system for a work vehicle, for example a truck-mounted forklift, with at least one consumer, wherein the drive system comprises:
a hydraulic pump configured to drive the at least one consumer,
an electric motor mechanically coupled to the hydraulic pump, the electric motor being configured to drive the hydraulic pump, and
a open-loop or closed-loop control unit for open-loop or closed-loop controlling the electric motor and/or the hydraulic pump,
wherein the open-loop or closed-loop control unit is configured to open-loop or closed-loop control a volume flow that can be generated by the hydraulic pump.

2. The drive system according to claim 1, wherein the open-loop or closed-loop control unit is configured to open-loop or closed-loop control the volume flow at a request of the at least one consumer.

3. The drive system according to claim 2, wherein the request from the at least one consumer corresponds to a defined maximum power requirement of the at least one consumer.

4. The drive system according to claim 2, wherein the electric motor is configured to be open-loop or closed-loop controlled in response to at least one, preferably mechanical or electrical or hydraulic, signal generated by the request of the at least one consumer.

5. The drive system according to claim 1, wherein the open-loop or closed-loop control unit is configured to generate a proportional and/or constant volume flow depending on a function of the consumer.

6. The drive system according to claim 1, wherein the open-loop or closed-loop control unit is configured to open-loop or closed-loop control the volume flow based on the revolutions per minute of the hydraulic pump and/or a displacement volume per revolution of the hydraulic pump.

7. The drive system according to claim 1, wherein the hydraulic pump is a constant pump with a constant displacement volume per revolution of the hydraulic pump, preferably wherein the open-loop or closed-loop control unit is configured to open-loop or closed-loop control the volume flow based on the revolutions per minute of the hydraulic pump.

8. The drive system according to claim 1, wherein the hydraulic pump is a variable displacement pump, preferably wherein the open-loop or closed-loop control unit is configured to open-loop or closed-loop control the volume flow based on an adjustment parameter such as a swivel angle and/or the revolutions per minute of the hydraulic pump.

9. The drive system according to claim 1, wherein the open-loop or closed-loop control unit is configured to open-loop or closed-loop control the electric motor.

10. The drive system according to claim 1, wherein the open-loop or closed-loop control unit is configured to open-loop or closed-loop control the volume flow by at least one function request to the at least one consumer by an operating person, preferably in real time.

11. The drive system according to claim 1, wherein at least the electric motor and the hydraulic pump form one first hydraulic drive train for driving the at least one consumer, preferably, wherein the at least one consumer comprises at least two, for example, five consumers.

12. The drive system according to claim 11, wherein the open-loop or closed-loop control device is configured to open-loop or closed-loop control the volume flow based on a sum of the individual requests of the at least two consumers.

13. The drive system according to claim 11, wherein a primary consumer with a defined power requirement is arranged upstream of the at least one consumer in the first drive train, preferably wherein the drive system is configured to supply the primary consumer with a quantity of hydraulic oil to cover the defined power requirement by means of a device for open-loop controlling the prioritized energy supply.

14. The drive system according to claim 11, wherein the drive system has at least one second hydraulic drive train with a second electric motor and a second hydraulic pump mechanically coupled to the second electric motor.

15. The drive system according to claim 14, wherein the second drive train has at least one hydraulic motor, preferably for driving at least one wheel of the work vehicle, preferably wherein the second hydraulic pump is configured to drive the at least one hydraulic motor and/or wherein the second hydraulic pump is a two-way pump.

16. A work vehicle, in particular a truck-mounted forklift, with a drive system according to claim 1 and at least one consumer that can be driven by the drive system.
